(19) United States
(12) Patent Application Publication
(10) Pub. No.: US 2016/0288565 A1
(43) Pub. Date: Oct. 6, 2016

(54) VEHICLE WHEEL

(71) Applicant: Ford Global Technologies, LLC, Dearborn, MI (US)

(72) Inventor: Bassam Noweihed, Duesseldorf (DE)

(73) Assignee: Ford Global Technologies, LLC, Dearborn, MI (US)

(21) Appl. No.: 15/078,012

(22) Filed: Mar. 23, 2016

(30) Foreign Application Priority Data
Apr. 1, 2015 (DE) 102015205863.8

(51) Int. Cl. B60B 21/02

(52) U.S. Cl. CPC B60B 21/023

(57) ABSTRACT

A vehicle wheel rim with a center arranged between a rim shoulder on the outside of the rim and a rim shoulder on the inside of the rim. The rim shoulders spaced apart from one another in the axial direction, each ending in a rim flange at the axially outer or inner edge of the rim. Each delimited axially on the inside or outside by a hump on the outside of the rim and a hump on the inside of the rim. The center offset radially inwards and has a radially inner, low profile section and an elevated profile section offset radially to the outside of the inner, low profile section. A steep wall section extending between the elevated profile section and the rim shoulder on the inside of the rim.

### CROSS-REFERENCE TO RELATED APPLICATIONS

Not Applicable.

### BACKGROUND OF THE INVENTION

1. Field of the Invention

The present invention relates to a vehicle wheel, and more specifically to a vehicle wheel rim having an inwardly extending center.

2. Description of Related Art

A vehicle wheel includes a wheel rim to accommodate and hold a tire. The wheel rim connects via several spokes to a wheel flange of a light metal alloy wheel, or to a wheel disk. The wheel flange or the wheel disk fastens the wheel, via wheel bolts, to the hub of a motor vehicle. The wheels are loaded during use by rising and ebbing dynamic bending and torsion forces. The achievement of a low weight and compliance with desired NVH characteristics (Noise, Vibration, Harshness) also plays a significant role.

A wheel rim often includes an inwardly extending well or drop center whereby wheel rigidity increases the deeper, i.e. the further radially inward, the well or drop center is formed on the wheel rim. As opposed to a flat well or drop center that leads to a reduction in wheel rigidity and to a reduction in the resonant frequency of the wheel. A lower resonant frequency of the wheel results in undesirable NVH characteristics—the generation of noise perceived by the occupants of the motor vehicle. Desirable NVH characteristics are achieved by having a resonant frequency or rigidity of the wheel as high as possible.

The depth of the well or drop center is restricted by the spatial extent of a brake caliper, part of a conventional brake system of the motor vehicle, arranged in the inner space surrounded by the inside of the vehicle wheel. In particular, the maximum possible depth of the well or drop center of the wheel rim is determined by the height of the brake caliper. An increase in the braking power of the motor vehicle brake system rarely involves an increase in size of the brake caliper since material is conventionally added to the brake caliper to increase its rigidity. A flatter well or drop center leads to inferior NVH characteristics, as mentioned above.

### SUMMARY OF THE INVENTION

One example of the present invention includes a wheel rim, typically for use with a motor vehicle, having a contoured outer surface. The outer surface including an outer rim shoulder and an inner rim shoulder. The outer surface including a center portion spaced radially inward of the inner and outer rim shoulders. The center portion includes a low profile section and an elevated section, with the elevated section spaced radially outward of the low profile section. A steep wall section extends between the elevated section and the inner rim shoulder.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a side, partial sectional view of a wheel with a wheel rim according to a first exemplary embodiment.

FIG. 2 shows an axial profile of the wheel rim of FIG. 1.

FIG. 3 shows an axial profile of a wheel rim according to a second exemplary embodiment.

### DETAILED DESCRIPTION OF THE PREFERRED EMBODIMENTS

The following description of the preferred embodiment(s) is merely exemplary in nature and is in no way intended to limit the invention, its application, or uses.

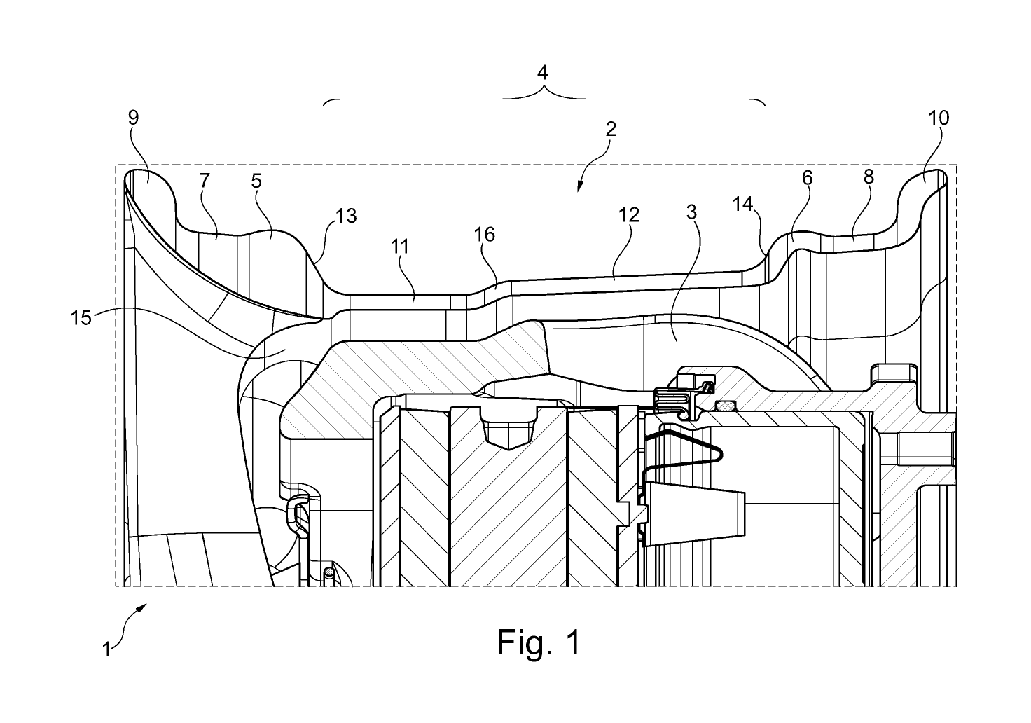

FIG. 1 illustrates partial, sectional view of a wheel rim, seen generally at 2, of a vehicle wheel 1 according to an exemplary embodiment of the present invention. The wheel 1 represented in FIG. 1 is shown mounted on a motor vehicle (not shown). FIG. 1 further illustrates a brake caliper 3 in addition to wheel 1 and wheel rim 2. As understood, the wheel 1 and correspondingly wheel rim 2 rotate about a rotational axis defining an axial direction of the wheel rim 2.

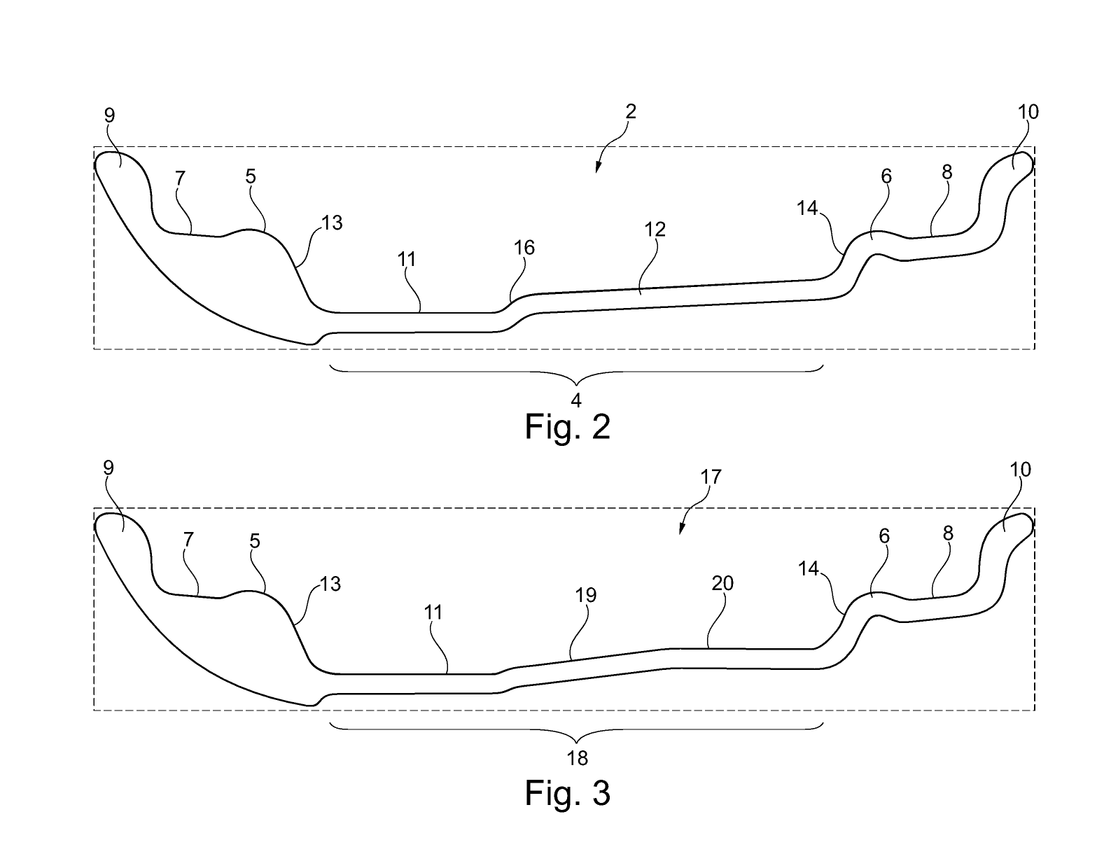

As illustrated in FIGS. 1 and 2, the wheel rim 2 includes a center portion, sometimes referred to as a well or drop center, seen generally at 4. The center portion 4 extends in the axial direction of wheel rim 2 between two axially spaced humps 5, 6. Outside rim hump 5 is arranged on the outside of the rim 2 and inner rim hump 6 on the inside of the rim 2. An outer rim shoulder 7 on the outside of the rim adjoins outer rim hump 5 on the outside of the rim 2 in the direction running axially to the outside. In a similar manner, an inner rim shoulder 8 on the inside of the rim 2 adjoins inner rim hump 6 on the inside of the rim 2 in the direction running axially to the inside. The outer rim shoulder 7 on the outside of the rim 2 extends axially to an outer rim flange 9 on the outside of the rim 2. The inner rim shoulder 8 on the inside of the rim 2 extends axially to an inner rim flange 10 on the inside of the rim 2.

As set forth above, the wheel rim 2 includes center portion 4 arranged between the rim shoulder 7 on the outside of the rim 2 and a rim shoulder 8 on the inside of the rim 2. “Inside” should be understood as the side of the wheel rim 2 facing towards the vehicle in the mounted state of the wheel rim on a vehicle. “Outside” correspondingly designates the side of the wheel rim 2 facing away from the vehicle. The rim shoulders 7, 8 on the outside and on the inside of the rim 2 are spaced apart from one another in the axial direction. The rim shoulders 7, 8 each end in a rim flange 9, 10 at the axially outer or inner edge of the rim 2. The rim shoulders 7, 8 are also delimited respectively by a hump 5 on the outside of the rim 2 and a hump 6 on the inside of the rim 2; i.e., a bulging of the rim shoulders 7, 8 on the outside of the rim and on the inside of the rim.

In the case of the exemplary embodiment represented in FIGS. 1 and 2, the center portion 4, is in its entirety, i.e. in its entire axial profile, offset radially to the inside of both humps 5, 6. Center portion 4 is in its entirety also offset radially to the inside of both rim shoulders 7, 8. To achieve a center portion 4 as low as possible for a high rigidity of the wheel rim, center portion 4 furthermore has a radially inner, low profile section 11 and adjacent thereto is a radially outwardly offset, elevated profile section 12. Center portion 4 formed by both profile sections 11 and 12 is offset radially to the inside of both humps 5 and 6 deep enough that both low profile section 11 and elevated profile section 12 transition into respective humps 5, 6 via respective steep wall sections 13, 14.

The center portion 4 is in its entirety, i.e. in its entire axial profile, offset radially inwards from both humps 5, 6 and both rim shoulders 7, 8. It furthermore has a radially inner, low profile section 11 and in adjacent elevated profile section 12 offset radially to the outside. Both the low and the elevated profile sections 11, 12 of the center portion 4 are arranged as low as possible in the wheel rim 2 with respect to the humps 5, 6 that axially delimit the center portion 4 to give the wheel rim 2 the desired high degree of rigidity and good NVH characteristics. The elevated profile section 12, elevated with respect to the low profile section 11, provides sufficient space for a rigid, larger, in particular higher brake caliper, the height of which is restricted at the top by the wheel rim 2 and with which a greater braking power for the motor vehicle can be achieved. The relatively low profile of the center portion 4 extending across the entire axial direction of the wheel rim 2 ensures a rigid formation of the wheel rim and a high resonant frequency of the wheel rim 2 or of an entire wheel of which the wheel rim 2 according to the invention is a component. The weight of the wheel rim according to the invention is not substantially increased compared to a conventional wheel rim with a normal well or drop center.

The steep wall section 14 on the inside of the rim has an angle of inclination between approximately 45 degrees and approximately 90 degrees, preferably between approximately 60 degrees and approximately 85 degrees and even more preferably between approximately 70 degrees and approximately 80 degrees with respect to the axial direction of wheel rim 2. In the exemplary embodiment of FIG. 1 of wheel rim 2, the steep wall section 13 on the outside of the rim also has such an inclination with respect to the axial direction of wheel rim 2. Steep wall sections 13 and 14 and particularly steep wall section 14 on the inside of the rim contribute to an increase in the rigidity of wheel rim 2.

As illustrated, the transition from the elevated profile section 12 to the hump 6 on the inside of the rim has a steep wall section 14. The steep wall section has an angle of inclination between approximately 45 degrees and approximately 90 degrees, preferably between approximately 60 degrees and approximately 85 degrees and even more preferably between approximately 70 degrees and approximately 80 degrees with respect to the axial direction of the wheel rim. In a similar manner, the transition from the low profile section of the center portion 4 to the hump 5 on the outside of the rim preferably also has a steep wall section 13. This can be between approximately 45 degrees and approximately 90 degrees, preferably between approximately 60 degrees and approximately 85 degrees and even more preferably between approximately 70 degrees and approximately 80 degrees. The respective steep wall sections 13, 14 between the center portion 4 and the corresponding humps 5, 6 and in particular the steep wall section 14 on the inside of the rim 2 which forms the transition from the elevated profile section 12 of the center portion 4 to the hump 6 on the inside of the rim 2 further improves the rigidity of the wheel rim 2 thereby increasing the resonant frequency of the wheel rim 2.

Both profile sections 11 and 12 are selected in terms of their total axial profile in relation to brake caliper 3 such that a minimal distance 15, preferably approximately 5 mm, remains between brake caliper 3 and center portion 4 of wheel rim 2. As apparent in FIG. 1, the transition between low profile section 11 and elevated profile section 12 is formed, in the case of the represented exemplary embodiment of wheel rim 2, as a scarp 16 to achieve an optimum adjustment to the outer surface of brake caliper 3 and simultaneously achieve maximum rigidity and high resonant frequency of wheel rim 2.

The scarp 16 preferably has an angle of inclination between approximately 45 degrees and approximately 90 degrees, preferably between approximately 50 degrees and approximately 80 degrees and even more preferably between approximately 60 degrees and approximately 70 degrees with respect to the axial direction of the wheel rim. The scarp 16 also improves the rigidity of the wheel rim 2 thereby increasing the resonant frequency of the wheel rim.

In contrast to low profile section 11, elevated profile section 12 correspondingly has an inclination increasing from the outside of the rim to the inside of the rim 2 with respect to the axial direction of the wheel rim 2. The inclination is preferably approximately 2 to approximately 4 degrees and even more preferably approximately 3 degrees.

Inclining the elevated profile section 12 with respect to the axial direction of the wheel rim increases installation space for the brake caliper, which, in the mounted state of the wheel rim on the motor vehicle, is arranged below the wheel rim 2.

FIG. 3 represents a detailed view of an axial profile of a wheel rim 17 according to a second exemplary embodiment. As illustrated, the wheel rim 17 differs from wheel rim 2 in the configuration of the center portion. Wheel rim 17 has a center portion 18, the lower profile section 11 of which substantially corresponds to that of wheel rim 2 from FIG. 2. Instead of the scarp 16 in FIG. 2, wheel rim 17 has a flat ramp 19. Flat ramp 19, having an angle of inclination between approximately 2 and approximately 10 degrees, preferably between approximately 4 and 6 degrees and even more preferably approximately 5 degrees with respect to the axial direction of wheel rim 17. The flat ramp 19 forms a transition between a low profile section 11 of center portion 18 and an elevated profile section 20 of center portion 18. In contrast to elevated profile section 12 of wheel rim 2 represented in FIG. 2, elevated profile section 20 of wheel rim 17 has substantially no inclination with respect to the axial direction of wheel rim 17.

A further advantageous configuration of the invention provides a transition as the flat ramp 19 extends between the low profile section 11 and the elevated profile section 20. The flat ramp has an angle of inclination between approximately 2 and approximately 10 degrees, preferably between approximately 4 and 6 degrees and even more preferably approximately 5 degrees with respect to the axial direction of the wheel rim. Because of the flat ramp 19, a deeper axial profile of the center portion 18 over a larger axial section can be realized overall, because of which the rigidity of the wheel rim 2 can be increased once again. While disclosed as flat, i.e. straight, the ramp 19 may also have a curved or complex configuration.

The center portion 18 configuration enables a slightly more rigid formation of a wheel rim 17, and a slightly higher resonant frequency and better NVH characteristics of wheel rim 17 compared to the wheel rim 2 shown in FIGS. 1 and 2 since steep wall section 14 on the inside of the rim in FIG. 3 is once again slightly lengthened in the radial direction of wheel rim 17 compared to the steep wall section 14 on the inside of the rim in FIG. 2.

The wheel rims 2, 17 according to the disclosed examples and described above are not restricted to the embodiments disclosed herein, rather also comprise further embodiments with the same effect. The center portion 4 can also have more than one elevated profile section opposite the radially furthest inner, lowest profile section. An exemplary embodiment with such a configuration could have a profile rising in a step-like manner from the lowest profile section.

Against this background, the wheel rim 2, 17 with a center portion 4, in particular for a motor vehicle, has a high degree of rigidity and good NVH characteristics and simultaneously provides adequate space for arrangement of a large brake caliper to achieve high braking power of the motor vehicle. The wheel rim should furthermore be of lightweight construction and it should be possible to produce it at low cost.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A wheel comprising:
a rim with a drop center arranged between a rim shoulder on the outside of the rim and a rim shoulder on the inside of the rim, said rim shoulders spaced apart from one another in the axial direction and each ending in a rim flange;
an inside rim hump near the inside of the rim and an outside rim hump near the outside of the rim;
said drop center in its entirety offset radially inwards from both inside and outside rim humps, and having a radially inner, low profile section and an elevated profile section wherein said elevated profile section is radially outward from said low profile section; and
a steep wall section extending from the elevated profile section to the inside rim hump on the inside of the rim.

2. The wheel of claim 1 wherein said steep wall section has an angle of inclination between approximately 60 degrees and approximately 85 degrees with respect to the axial direction of the wheel rim.

3. The wheel of claim 1 wherein said steep wall section has an angle of inclination between approximately 70 degrees and approximately 80 degrees with respect to the axial direction of the wheel rim.

4. The wheel of claim 1 wherein the elevated profile section slopes outwardly with respect to the axial direction of the wheel rim.

5. The wheel of claim 4 wherein the slope is approximately 2 to approximately 4 degrees.

6. The wheel of claim 1 including a scarp between the low profile section and the elevated profile section.

7. The wheel of claim 6 wherein the scarp has an angle of inclination preferably between approximately 50 degrees and approximately 80 degrees with respect to the axial direction of the wheel rim.

8. The wheel of claim 7 wherein the scarp has an angle of inclination preferably between approximately 60 degrees and approximately 70 degrees with respect to the axial direction of the wheel rim.

9. The wheel of claim 1 including a ramp section between said low profile section and the elevated profile section.

10. The wheel of claim 9 wherein said ramp section slopes outwardly at an angle of inclination between approximately 4 and 6 degrees with respect to the axial direction of the wheel rim.

11. The wheel of claim 10 wherein said ramp section slopes outwardly at an angle of inclination of approximately 5 degrees with respect to the axial direction of the wheel rim.

12. The wheel of claim 1 wherein the wheel rim is formed of a light metal alloy.

13. A wheel rim comprising:
a contoured outer surface, including an outer rim shoulder and an inner rim shoulder and a center portion, spaced radially inward of said inner and outer rim shoulders, having a low profile section and an elevated section spaced radially outward of said low profile section; and
a steep wall section between said elevated section and said inner rim shoulder.

14. The wheel rim of claim 13 wherein said low profile section is substantially parallel to a rotational axis of the wheel rim and said elevated section is skewed with respect to a rotational axis of the wheel rim.

15. The wheel rim of claim 13 including a scarp between said low profile section and said elevated profile section.

16. The wheel rim of claim 13 including a ramp between said low profile section and said elevated profile section.

17. The wheel rim of claim 16 wherein said low profile section is substantially parallel to a rotational axis of the wheel rim, said elevated section is substantially parallel to a rotational axis of the wheel rim, and said ramp is skewed with respect to a rotational axis of the wheel rim.

18. The wheel rim of claim 15 wherein said steep wall section has an angle of inclination between approximately 60 degrees and approximately 85 degrees with respect to a rotational axis of the wheel rim and the scarp has an angle of inclination preferably between approximately 60 degrees and approximately 70 degrees with respect to a rotational axis of the wheel rim.

19. The wheel rim of claim 18 wherein said low profile section is substantially parallel to a rotational axis of said wheel rim and said elevated section is skewed with respect to a rotational axis of said wheel rim.
